(19) United States
(12) Patent Application Publication
(10) Pub. No.: US 2003/0233916 A1
(43) Pub. Date: Dec. 25, 2003

(54) Tool with opposing driving and telescopic pick-up functions

(76) Inventor: Burton Kozak, Chicago, IL (US)

Correspondence Address: CHERSKOV & FLAYNIK, THE CIVIC OPERA BUILDING, 20 NORTH WACKER DRIVE, SUITE 1447, CHICAGO, IL, 60606, US

(21) Appl. No.: 10/606,493

(22) Filed: Jun. 26, 2003

Related U.S. Application Data
(63) Continuation-in-part of application No. 10/036,617, filed on Dec. 21, 2001, now abandoned.

(51) Int. Cl. B25B 23/00

(52) U.S. Cl. 81/439

(57) ABSTRACT

A combination tool with a driving implement and a pick-up implement comprises a tool handle from which extend a driving implement in one direction and a telescopic pick-up implement in the opposite direction. The two implements are constructed and function totally independently from each other. Also described are several devices facilitating the deployment of the pick-up implement out of the tool handle.

This is a continuation-in-part application of application Ser. No. 10/036,617 filed on Dec. 21, 2001.

### BACKGROUND OF THE INVENTION

1. Field of the Invention

The present invention relates to driving tools, and more specifically to tools equipped with a telescopic pick-up wand.

2. Description of the Prior Art

As manufacturers have striven to produce ever more compact machinery and equipment, the need has developed to provide tools that would allow one to manipulate or retrieve fasteners, nuts, washers, debris, etc. . . . located outside the reach of human fingers. Often, such tools take the form of telescopic wands terminating in any of a variety of grasping or fetching implements. Two recent U.S. Pat. Nos. 5,487,576 to DuVivier (1996) and 5,878,637 to Liu (1999) are typical in that the telescopic wand extends from the same region of a hand tool that also imparts torque to whatever workpiece is to be turned by the tool. Thus a worker who is driving fasteners and wants to retrieve a fastener that he just dropped must remove the driving bit so as to access the extendable pickup device. This is cumbersome, time-consuming, and, especially, hazardous as many such tasks are performed in cramped situations, near moving machinery or high voltage terminals, where a dropped tool may cause extensive damage.

U.S. Pat. No. 5,878,637 to Liu teaches a telescopic pick-up wand that may hold a tool-bit interchangeably with a pick-up device. The disadvantage in this device is that it is limited in the size of driver tool-bits that it can employ and in the torque that can be applied thereto without damaging the pick-up wand.

Thus there is a need in the art for a tool that would combine driving and pick-up functions. Such a tool may be either manually or power driven.

### SUMMARY OF THE INVENTION

It is an object of the present invention to provide a driving tool with a telescopic pick-up wand that remedies disadvantages in the prior art.

It is a further object of the present invention to provide a driving tool with a telescopic pick-up wand that is independent of the driving function of the tool. It is a feature of the present invention that it provides for a tool handle wherein the pick-up wand and the driving shaft extend from opposing ends of the handle. It is an advantage of the present invention that the same tool can perform pick-up and driving functions without the need for first removing driving bits to get access to the pick-up means.

It is another object of the present invention to provide a telescopic pick-up wand for power driven driving tools. It is a feature of the present invention that it provides for a tool handle wherein the pick-up wand is distinct from the driving shaft. It is an advantage of the present invention that a power tool can perform pick-up functions.

It is yet a further object of the present invention to provide a driving tool with a telescopic pick-up wand that includes means for positioning the wand at various angles from the longitudinal axis of the handle and also a means for facilitating the deployment (i.e. the folding out) of the pick-up wand. It is a feature of the present invention that it provides several embodiments of implements that facilitate the positioning of the wand in relation to the tool handle when the wand remains attached to the handle. It is an advantage of the present invention that the pick-up wand can be deployed quickly and cannot be misplaced.

In brief, the present invention provides for a tool handle from which extend a driving implement in a first direction and a telescopic pick-up implement in a second direction. Specifically, the invention provides for a combination driving and pick-up tool comprising a handle with a first end and a second end, a driving implement extending from said first end; and a telescopic pick-up implement extending from said second end with means being provided to facilitate the deployment of the pick-up implement from the tool handle.

Further objectives, features, and advantages of the present invention will become apparent from the following detailed description with appropriate reference to the accompanying drawing.

### BRIEF DESCRIPTION OF THE DRAWING

FIG. 1A is a cross-sectional view of a tool with opposite driving and pick-up implements in accordance with features of the present invention;

FIG. 1B is an alternative deployment shaft for use with the invented device, in accordance with features of the present invention;

FIG. 2A is a cross-sectional view of a tool with opposite driving and pick-up implements with the pick-up implement recessed in the tool's handle, in accordance with features of the present invention;

FIG. 2B is a cross-sectional view of a modification of a tool with opposite driving and pick-up implements with the pick-up implement recessed in the tool's handle, in accordance with features of the present invention;

FIGS. 3A and 3B are cross-sectional views of movable heels of a tool handle, in accordance with features of the present invention;

FIGS. 3C and 3D are cross-sectional views of removable heels of a tool handle, in accordance with features of the present invention;

FIG. 3E is a cross-sectional view of a tool handle in slidable communication with its heel, in accordance with features of the present invention;

FIG. 3F is a view of FIG. 3E taken along the line F-F, in accordance with features of the present invention; and

FIG. 4 is a schematic view of an embodiment of a tool with opposite driving and pick-up implements with the pick-up implement recessed in a power tool's handle, in accordance with features of the present invention.

### DETAILED DESCRIPTION

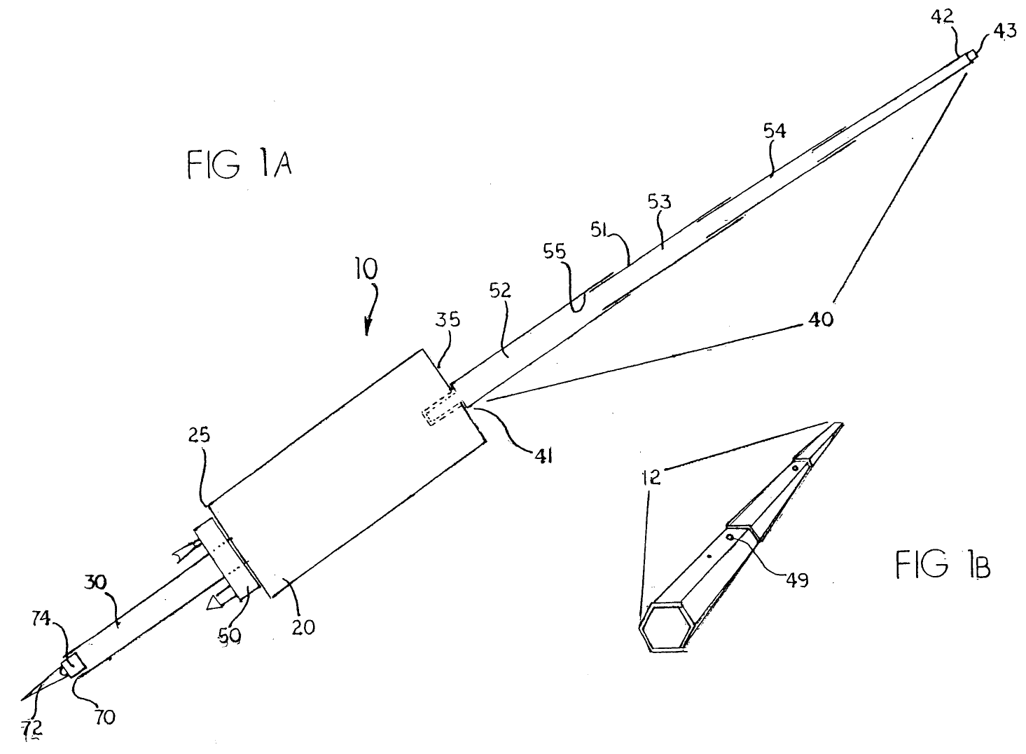

Referring to FIG. 1, the present invention provides a tool, designated as numeral 10, which comprises a torque-inducing driving implement extending in one direction and a telescopic pick-up implement extending in the opposite direction. The invented device includes a tool handle 20 with a first end 25 and a second end 35. From the first end 25 extends a conventional driving tool assembly 30. The second end 35 communicates with a telescopic member 40. Further provided are means to facilitate the storage, the positioning, and the deployment of the telescopic member, all relative to the handle.

Telescopic Member Detail

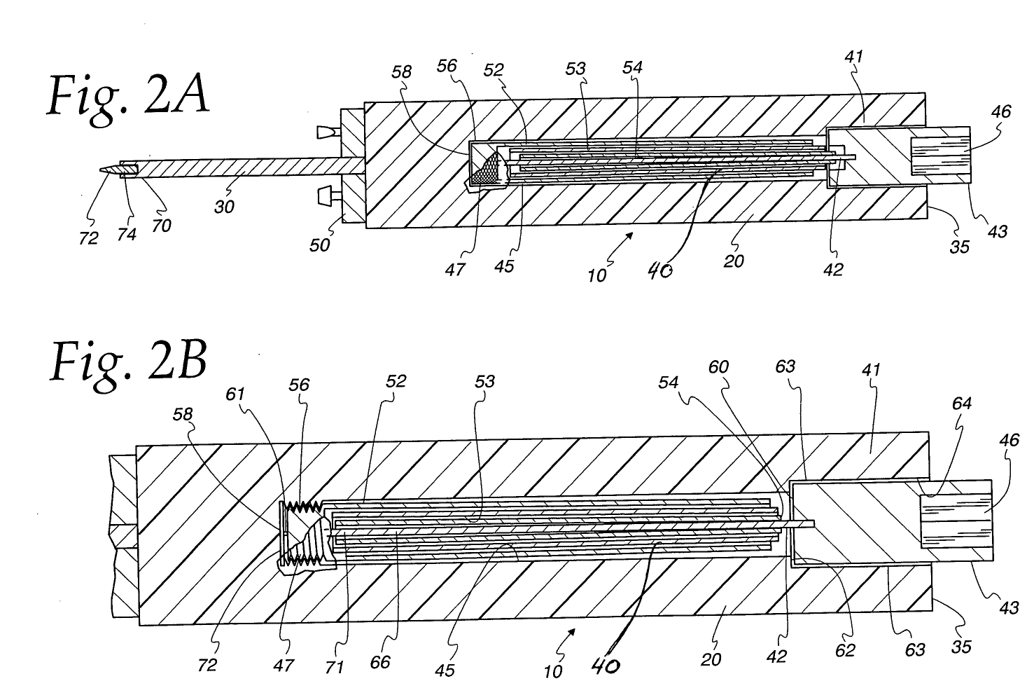

A salient feature of the invention is that the telescopic device extends in a direction generally different from the direction in which a torque-imparting shaft 30 extends. The present invention accommodates a myriad of telescopic member configurations. Also, the telescopic member (also referred to herein as the pick-up wand) is either removably attached to the tool handle 20, recessed in the handle, as shown in FIG. 2, or a combination thereof.

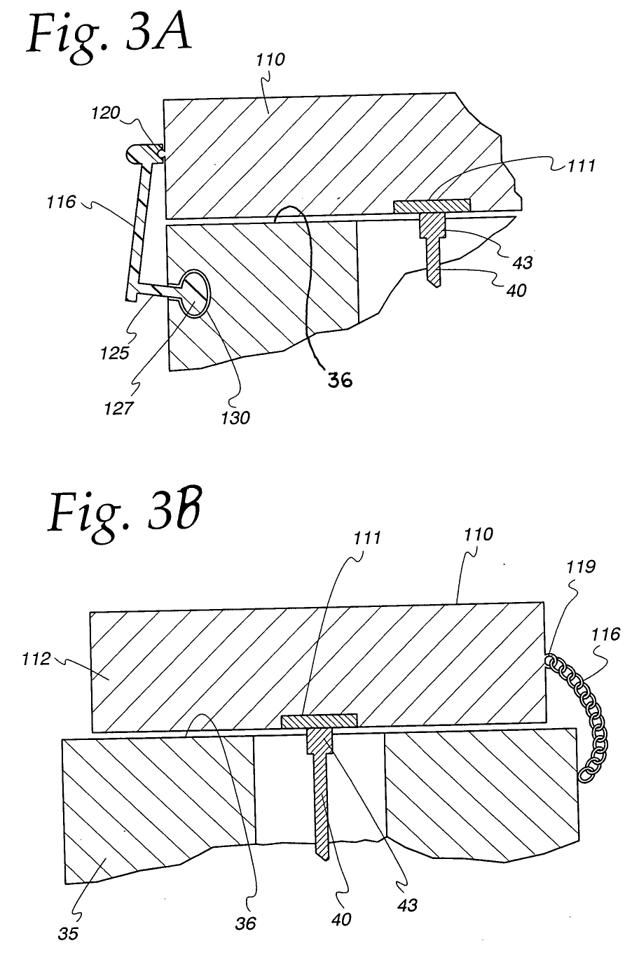

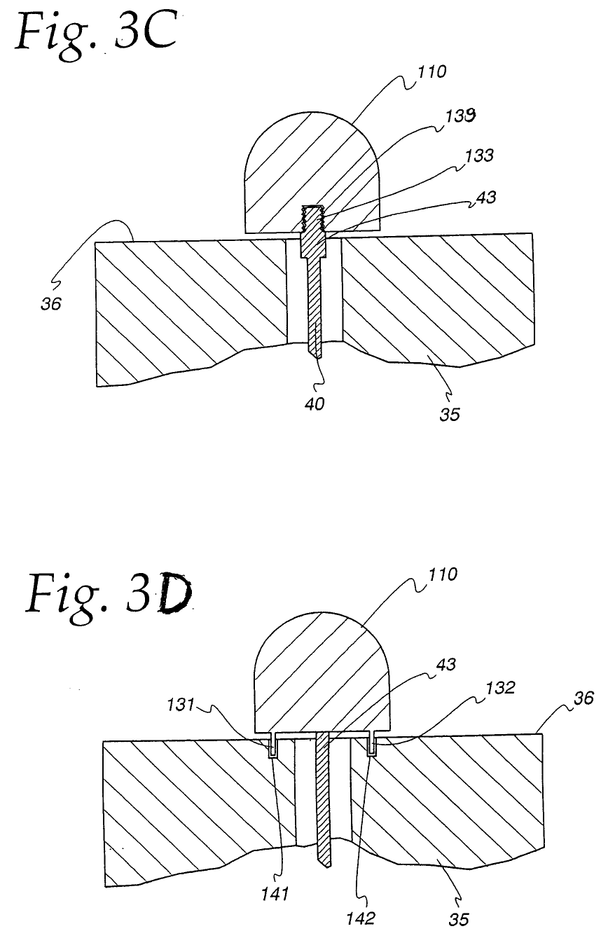

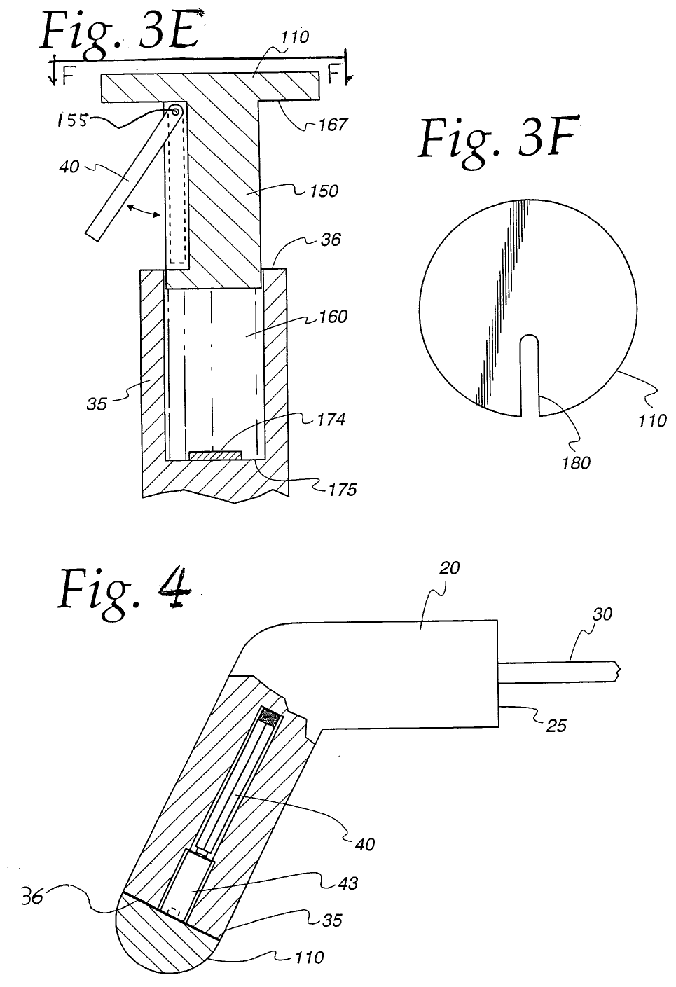

FIG. 1 depicts the telescoping member threadably received into the second end 35 of the handle. However, and as depicted in FIG. 2A, the telescoping member can be stored, and deployed from an interior portion of the handle defining a cavity. Finally, as depicted in FIG. 3E, the telescopic member can be stored in and deployed from a housing that is slidably received by an interior portion of the handle. In this embodiment the telescopic member 40 is in hingeable communication with the housing 150.

Generally, the telescoping member 40 comprises a first end 41 adapted to be attached to the handle, and a second end 42 adapted to retrieve hard to reach objects or detritus. The member further comprises concentrically-arranged tubular members 52, 53, 54, 58 each with sides tapering radially inwardly relative to the longitudinal axis of the member as the member extends away from the handle. The tapered arrangement facilitates deployment of the telescopic member up to the point where the tapered outer surface 51 of a second tube 53 frictionally engages a tapered inner surface 55 of a first tube 52 juxtaposed radially outward from the second tube 51. The telescopic member may be extended to its full length by pulling on the second end 42.

To prevent azimuthal relative motion between the concentrically-arranged tubular members, tubular members having non-circular cross-sections, such as elliptical, square or hexagonal cross-sections are utilized.

In one embodiment the telescoping member 40 is reversibly attached to an exterior region of the handle (such as its second end 35), or to an inside surface of the handle, by any of a variety of means. Such means include, but are not limited to, a press fit arrangement, a snap fit arrangement, or a male-female threaded configuration, the latter configuration of which is depicted in FIG. 1A.

The telescoping member is attached to the handle, so as to be collapsed after use, swung back into coaxial alignment with the longitudinal axis of the handle and hidden away inside the handle. In one exemplary attachment configuration, the telescopic member is adapted to be threaded into a threaded aperture located on the handle.

FIG. 1B depicts an exemplary embodiment 12 of the telescoping member 40. This embodiment 12 shows the telescopic member with hexagonal cross section. Also shown is a ball lock mechanism 49 (i.e. a ball-detent configuration) to reversibly lock the member in an extended configuration. The ball-lock mechanism is any standard spring ball lock configuration comprising a spherical body slidably received in an aperture formed in a surface opposing the spherical body when the telescopic member is fully extended. It should be noted that the spring ball configuration also can be utilized with a telescopic wand having a circular cross section, or other geometry.

FIG. 2A depicts the invented device wherein the telescopic member 40 is stored in an interior region of the handle 20 of the tool 10. The interior region defines a cavity 45, coaxial with the longitudinal axis of the handle. The cavity is adapted to house the telescopic member 40 when the telescopic member is un-deployed. The telescopic member 40 may be secured to the cavity 45 by a variety of means, a press fit among others. A press fit attachment is facilitated by forming a knurled section 47 on the end of the outer surface of the outermost tube. In the case where the telescopic member is permanently attached to the tool, the proximal end 56 of the first tube 52 is knurled so as to frictionally engage with a complementarily shaped female aperture 58 of the cavity, the aperture extending in the direction opposite the direction of deployment of the telescopic member. In the case where the telescopic member is to be reversibly attached to the handle, the proximal end 56 of the first tube 52 is threaded to facilitate its engagement with a threaded aperture defined by the female aperture 58.

In its un-deployed state the telescopic implement may be used as a magnetic nut setter and driver. Such an embodiment is illustrated in FIG. 2A where a standard size nut setter 43 such as a 5/16 inch hexagonal nut setter is attached to the distal end 42 of the telescopic wand. FIG. 2A depicts the nut setter fully nested in an aperture 64 formed at the distal end 63 of the cavity 45. The aperture 64 is formed of similar cross section to that of the nut setter so as to slidably receive the nut setter, but prevent azimuthal rotation of the nut setter when the setter is nested inside the aperture.

The nut setter is affixed reversibly (for example in a snap fit or a male-female threaded configuration) to the end 42 of the telescopic wand and comprises a hexagonal cavity 46 sized to receive a nut. The nut setter may be magnetic. The nut setter serves an additional function of preventing the terminal end of the telescope member from slipping completely within the confines of the cavity 46. In this regard, a proximal end 60 of the nut setter 43 comes to rest (when the telescopic member is in the fully retracted position) against an annular shoulder 62 defined by the proximal end 63 of the aperture 64.

Alternatively the cross section of the cavity 46 can be configured to slidably receive but rotatably confine standard driver bits. A bit confined in this instance is not physically connected to the telescopic member 40 but would be magnetic so as to draw the end 42 of the telescopic member 40 (heretofore equipped with the magnetic tip 43) from the confines of the handle cavity 45 when the bits are removed from the aperture 64.

FIG. 2B is an enlarged view of the handle section of FIG. 2A and depicts a modified arrangement for holding the pick-up wand in an undeployed configuration. A rod 66 extends from the tip 42 of the telescopic wand to the female aperture 58. The end 71 of the rod 66 proximal to the aperture 58 comprises a magnet 61 that abuts a ferrous layer 72 at the bottom of the aperture 58. Magnetic attraction between the magnet 61 and the ferrous layer 72 holds the wand in an undeployed position but the wand may be easily deployed by a gentle pull at the wand end 62.

Methods of fabricating a tool wand as described above are well known. Typically light metallic materials are employed. Also, one may use plastic or other non-electrically conducting materials such as ceramic non-static materials so that the pickup tool may be used in the immediate vicinity of microchips. In addition to the enhanced safety factor, the use of such materials avoids causing electric short-circuits in the presence of electric wiring or machinery.

Telescopic Member Detail

The distal end 42 of the telescopic member may terminate with a means for retrieving objects, in which case the telescopic member may be conceived as a If the objects to be retrieved are ferrous-containing materials, a magnetic substrate is attached to the end 42. An exemplary magnetic substrate is a nut setter such as a standard 5/16th of an inch sized setter.

If the objects to be retrieved are non-ferrous-based materials, and perhaps detritus (dust, wood shavings, plastic fasteners, and the like), a scoop, hook, or bit (wherein the bit is complementarily shaped to the targeted material) is removably secured to the end 42.

Furthermore, the end 42 may in addition (or, in the alternative) terminate in a male screw thread capable of receiving a pick-up tool comprising a cavity with a matching female thread. Other pick up tools and means to hold same are known in the art and these may be utilized in conjunction with the present invention.

Although the telescopic member is intended primarily for pick-up functions, it may also be used, when this is indicated, as a driving tool for a remote fastener. In that case the distal end 42 is adapted to hold an hexagonal bit holder adapted to receive fastener-engaging bits.

Various pick-up devices may be stored on a bit holding assembly via frictional fit on an exterior region of the handle or else inside a cavity in the handle.

Facilitating Deployment of the Telescopic Implement.

A specific feature of this invention is that means are provided to facilitate the deployment of the telescopic implement out of the tool handle. Outlined presently are four exemplary embodiments:

FIGS. 3A, 3B, 3C and 3D depict embodiments of such facilitating means wherein a cap 110 comprises a magnetized or ferrous disk 111 is in magnetic contact with the tip 43 of the telescopic wand 40. As an operator pulls gently on the cap 110, the latter attracts the tip 43 thus gently extending the wand 40 out of the handle 20. The cap 110 may be hingeably attached to the second end 35 of the handle 20 (See FIG. 3A) or, in the alternative, and as shown in FIG. 3B, it may be attached to the second end of the handle 35 by means of a chain or string 115.

The embodiments depicted in FIGS. 3A, 3B and 3D are used in conjunction with driving tools where the heel of the handle is held stationary while the handle itself is rotated. In these embodiments the cap 110 constitutes the heel of the driving implement. The cap's magnetic disk 111 is integrally molded to the cap and is designed to slide smoothly over the wand tip 43. The cap rim 112 is designed to slide smoothly on the surface 36 at the second end 35 of the handle 20. In FIG. 3A the cap 110 is attached to a plastic connecting member 116 that comprises what is commonly known as a “living hinge” 120 and a finger 125. The connecting member 116 is integrally molded to the cap 110. The finger 125 comprises a protuberance 127 that is designed to snap into a channel or groove 130 that runs along the circumferential periphery of the second end 35 of the handle. The groove 130 is so designed as to allow smooth travel of the protuberance 127 along the groove while preventing the protuberance from sliding out of the groove. In FIG. 3A the chain 115 is removably attached to the cap 110 by means of a clip 119.

FIGS. 3C and 3D depict alternative embodiments of deployment facilitating means wherein a cap 145, adapted to be grasped by hand, is removably attached to the tip 43 of the wand 40. For instance, as shown in FIG. 3C, the cap 145 may contain a female thread 139 adapted to receive a male thread 133 on the tip 43. The tap itself may be ferrous or magnetized and thus allow the use of the wand/cap combination as a sturdy pick-up tool. In such a case, and as shown in 3D, the cap 145 may be held in place by the magnetic attraction with the tip 43. The cap 145 is further secured to the second end 35 by means of two prongs 146, 147 adapted to be received by cavities 148, 149 in the second end 35.

FIG. 3E depicts another alternative embodiment of a telescopic wand deployment device. The wand 40 is pivotably attached to a housing 150 at a pivot post 155. The housing 150 is adapted to be slidably received in a cavity 160 in the handle 20. The housing is held in a retracted position within the handle 20 by means of magnetic attraction. Such attraction may be effected by placing a magnet 174 at the bottom 175 of the cavity 160. The housing 150 has a cap 110 adapted to be grasped by the tool's operator. The underside 167 of the cap 110 is adapted to slide smoothly on the rim 36 of the cavity 160. Both the cavity 160 and the housing 150 are cylindrical in shape so as to allow rotation of the housing inside the cavity. As shown in FIG. 3D, the wand 40 may be deployed at any angle between 0 and 180 degrees with respect to the driving tool 30. To this end the cap 110 comprises a notch 180 to allow deployment of the wand 40 above the plane of the cap 110 as depicted in FIG. 3F which is a planar view of the cap 110 in FIG. 3E along the line F-F.

Handle Detail

As shown in FIG. 1, an embodiment of the present invention comprises a standard tool handle 20 with a tool driving implement 30 extending from one end of the handle and a telescopic pick-up wand 40 extending from the opposite end. In all essential particulars the driving tool/handle combination is identical to manual- or power driven-screw (or other) drivers that are commercially available at present. The pick-up wand/handle combination is standard as well.

As noted supra, the telescopic member can be either attached to an outer surface of the handle 20 as depicted in FIG. 1 or else nested inside the handle, as depicted in FIG. 2. An external attachment configuration may be preferred when the tool in question is a power tool. Under these circumstances one usually prefers that the innards of the tool handle be reserved for the tool power plant (electric motor or air turbine).

Yet, the telescopic member 40 also may be embedded inside the handle of a power tool. This can be accomplished for power tools where the handle of the tool is aligned along the line of action of the driving tool as well as for tools where the handle of the tool is not along the line of action of the driving tool but perpendicular or otherwise inclined thereto (See FIG. 4).

Deployment and retraction of the telescopic member is performed manually. One may extend the pick-up wand by attaching the telescopic member 40 to the second end 35 and then pulling manually. In the alternative, one may allow the shaft end 42 to project from the handle even when the wand is fully retracted.

As shown in FIG. 1, the tool also may comprise a circumferential bit-holding assembly 50. The bit-holding assembly may be used to store pick-up tools. This assembly may take the form of a slip-on annulus slidably received by the fastener driving shaft 30. Alternatively, the bit holding means may consist of an array of cavities formed in the handle so as to store bits in a friction-fit capacity.

Another bit-holding embodiment is disclosed in “A Hand Tool with Opposing Drive Ends and Storage for Multiple Tool Bits,” U.S. patent application Ser. No. 09/918,958, Pub. No.: US 2003/0024356, with the same inventor as the present invention and incorporated herein by reference. U.S. patent application Ser. No. 09/918,958 discloses a tool with a handle, a driving shaft, an annulus that is slidably received by the driving shaft and whereon bits are stored with their driving end pointing towards the handle. The handle itself may comprise an annular cavity coaxial with the driving shaft so configured that the annulus may be slid up against the handle until all the bits are wholly contained therein. Furthermore, one may provide a window opening parallel to the driving shaft on the side of said cavity so that one may access a bit stored in said cavity by rotating the annulus until the desired bit comes into view.

A great variety of materials may be used to fabricate the handle. These include, but are not limited to wood, plastics, rubber, KEVLAR, fiberglass, Bakelite, resins, etc. . . . .

Driving Tool Details

There are no limitations on the driving tool assembly 30. Any presently available driver assembly may be employed and the present invention does not address the driver assembly as such. It may consist of a shaft terminating in a standard working tool configuration, such as a straight blade 72, a Philips tip, a socket, a threaded aperture, a threaded rod, a quick-disconnect, or standard accessories with a 5/16 inch hex rear and ¼ inch front. Alternatively, the terminal end of the shaft may define an aperture adapted to receive a variety of different tool bits. In such instances, the end of the shaft would interact with the bits in a standard socket-insert configuration, whereby the end of the shaft defines a female socket adapted to receive a complementary shaped insert 74. Typically, non-circular sockets and inserts are utilized to prevent turning of the inserts. An exemplary socket size suitable for the end 70 of the driving portion is a one-quarter-inch hex female socket.

In summary, the present invention provides for a tool handle from which extend a driving implement in one direction and a telescopic pick-up implement in a different direction. The two implements are constructed and function totally independently from each other.

Although the present invention has been described with a certain degree of particularity, the described embodiments have been presented by way of example only and numerous modifications and alterations may be made thereto without departing from the spirit and scope of the invention as set forth in the appended claims.

The embodiment of the invention in which an exclusive property or privilege is claimed is defined as follows:

1. A combination driving and pick-up tool comprising:
a handle with a first end and a second end;
a driving implement extending from said first end;
a telescopic member embedded in said handle; and
means attached to the handle to facilitate deployment of said telescopic member from said second end.

2. The combination tool as recited in claim 1 wherein said driving implement is manually-driven.

3. The combination tool as recited in claim 1 wherein said driving implement is power-driven.

4. The combination tool as recited in claim 1 wherein said driving implement is designed to be used in conjunction with a plurality of tool bits.

5. Th combination tool as recited in claim 1 wherein said handle comprises tool bit storing cavities.

6. The combination tool as recited in claim 5 wherein said cavities are electrically insulated from the handle.

7. The combination tool as recited in claim 1 wherein said member comprises a plurality of concentrically aligned tubes with a common longitudinal axis.

8. The combination tool as recited in claim 7 wherein said concentrically arranged tubes have a non-circular cross-section.

9. The combination tool as recited in claim 7 wherein said tubes are electrically insulative.

10. The combination tool as recited in claim 1 wherein said telescopic member terminates with a magnet.

11. The combination tool as recited in claim 1 wherein said telescopic member comprises means to receive detachable bits.

12. The combination tool as recited in claim 1 wherein said telescopic member comprises a pick-up implement.

13. The combination tool as recited in claim 1 wherein said deployment means utilizes magnetic attraction.

14. The combination tool as recited in claim 1 wherein said telescopic member terminates in a magnet and said deployment means comprises a ferrous substrate in rotatable communication with the second end.

15 The combination tool as recited in claim 14 wherein said ferrous substrate is attached to said deployment means and in slidable communication with a periphery of said handle.

16. The combination tool as recited in claim 1 wherein said member deployment means comprises a cap magnetically attached to said telescopic member and in slidable communication with a periphery of said second end of said handle.

17. The combination tool as recited in claim 16 wherein said cap is attached to said handle by means of a removable chain.

18. The combination tool as recited in claim 16 wherein said cap is attached to said handle by means of a hinge designed to be in slidable communication with said periphery of said handle.

19. The combination tool as recited in claim 1 wherein said telescopic member deployment means comprises a housing adapted to be slidably received within said handle and to which said telescopic member is pivotably attached.

20. The combination tool as recited in claim 19 wherein said housing is retractably held within said handle by a magnet.

21. The combination tool as recited in claim 1 wherein said member comprises a nut setter.

22. The combination tool as recited in claim 21 wherein said nut setter is attached to said telescopic member.

23 The combination tool as recited in claim 1 wherein said member deployment means comprises a magnetizable cap that may be slidably rotated while remaining in magnetic contact with said pick-up implement.

24. A combination driving and pick-up tool comprising:
a handle with a first end and a second end, said handle comprising tool bit storing cavities;
a driving implement extending from said first end adapted to be used in conjunction with a plurality of tool bits;
a telescopic pick-up implement deployable from said second end and comprising a plurality of electrically insulative concentrically aligned tubes with a common longitudinal axis; and
means attached to the handle to facilitate deployment of said implement from said second end.

25. The combination tool as recited in claim 24 wherein said telescopic pickup implement terminates with a magnet.

26. The combination tool as recited in claim 24 wherein said telescopic pickup implement is terminated with a removably attached nut setter.

27. The combination tool as recited in claim 24 wherein said concentrically arranged tubes have a non-circular cross-section.

28. The combination tool as recited in claim 24 wherein said handle, driving implement, and pick-up implement are aligned along an identical longitudinal axis.

29. The combination tool as recited in claim 24 wherein said pick-up implement deployment means comprises a magnetizable cap that is attached to said handle.

30. The combination tool as recited in claim 24 wherein said pick-up implement deployment means comprises a cap attached to said implement.

31. The combination tool as recited in claim 24 wherein said pick-up implement deployment means comprises a magnetizable cap attached to said implement.
